(19) United States
(12) Patent Application Publication
(10) Pub. No.: US 2004/0028823 A1
(43) Pub. Date: Feb. 12, 2004

(54) Multi-layer coating process to achieve a highly saturated color appearance on a vehicle

(76) Inventor: Wilfried Dutt, Wermelskirchen (DE)

Correspondence Address: E I DU PONT DE NEMOURS AND COMPANY, LEGAL PATENT RECORDS CENTER, BARLEY MILL PLAZA 25/1128, 4417 LANCASTER PIKE, WILMINGTON, DE, 19805, US

(21) Appl. No.: 10/216,257

(22) Filed: Aug. 8, 2002

(51) Int. Cl. B05D 3/02; B05D 1/36

(52) U.S. Cl. 427/385.5; 427/407.1

(57) ABSTRACT

A process and materials for coating motor vehicles with a multi-layer tricoat finish that achieves high color saturation, with excellent depth of color and glamour, without sacrificing weatherability. The process eliminates the use of a tinted clearcoat and its associated problems.

### BACKGROUND OF THE INVENTION

This invention is directed to a process and materials for applying a multi-layer coating over a substrate that achieves a highly saturated color appearance. In particular, this invention is directed to a process for coating motor vehicles such as automobiles or trucks during their original manufacture with a multi-layer coating that achieves excellent color saturation with depth of color and glamour, without sacrificing weatherability.

Automobile and truck bodies are treated with multiple layers of coatings which enhance the appearance of the vehicle and also provide protection from corrosion, scratch, chipping, ultraviolet light, acid rain and other environmental conditions. Base coat/clear coat finishes for automobiles and trucks have been commonly used over the past two decades. Kurauchi et al U.S. Pat. No. 4,728,543 issued Mar. 1, 1988 and Benefiel et al U.S. Pat. No. 3,639,347 issued Feb. 1, 1972 show the application of a clear coat over a color coat or basecoat in a “wet on wet” application, i.e., the clear coat is applied before the base coat is completely cured.

The desire for even more unique and attractive color styling has led the auto industry to utilize a basecoat/tinted clearcoat process, whereby a lightly pigmented clear coat is applied over a pigmented basecoat in a wet on wet application, to provide a finish of automotive quality and appearance with excellent color saturation, depth of color and glamour, for both solid color and effect finishes. Usually, this process involves applying a lightly pigmented clearcoat over a regular pigmented basecoat in the same color area, i.e., red over red, blue over blue, yellow over yellow, to significantly enhance the individual basecoat color shade and provide very deep, clean, vibrant, high end colors.

Unfortunately, the durability of these tinted clear coats has left much to be desired, since the pigments used therein are subject to UV degradation. Often, chalking, cracking and flaking occur after relatively short periods of exposure to weathering, necessitating costly refinishing. Various ideas have been proposed to solve the durability problems. One approach employs higher levels and different types of UV fortification but this has been met with only limited success. Another approach is to apply an additional layer of a regular clearcoat on top of the basecoat/tinted clearcoat finish, in order to avoid potential warranty claims. This approach, however, dramatically increases manufacturing costs and results in lost production, since the vehicle must be sent through the painting process a second time. In addition to the forgoing problems, a separate paint circulation system is also needed to accommodate a tinted clearcoat in an auto manufacturer's paint shop. Since tinted clearcoats are used only for a limited number of high-end colors and the rest of the color range in a basecoat/clearcoat process still requires the application of a regular untinted clearcoat, contamination of the regular clearcoat lines must be avoided. Redundant clearcoat circulation systems are therefore needed which are extremely expensive and occupy valuable floor space.

Therefore, there is still a need for a process that can accomplish the same tinted clearcoat style of colors without the use of a tinted clear coat.

### SUMMARY OF THE INVENTION

The present invention is directed to a process for coating an automotive substrate with a multi-layer tricoat finish to achieve a highly saturated color appearance, comprising:

(a) applying a first solid color or effect color basecoat composition to a surface of an automotive substrate;

(b) thereafter applying a second, different, transparent or semi-transparent basecoat composition preferably free of flake or other effect pigments;

(c) subjecting the combined basecoats to an intermediate drying step;

(d) applying over said basecoat layers, an untinted clear coat composition; and

(e) simultaneously curing the resulting tricoat finish together in a single bake.

The process of this invention can be operated in a single pass continuous in-line paint application process or in stationary batch process.

The present invention eliminates the use of tinted clearcoats and their associated problems, while at the same time providing a finish that is of automotive quality and appearance and has high color saturation, with excellent depth of color and desired glamour.

By tricoat finish, it is meant that three different, consecutive coating layers are applied over the substrate.

Also as used herein, color saturation is determined according to Ullmann's Encyclopedia of Industrial Chemistry, Vol. A20, page 259.

The claimed invention further includes coating materials and waterborne basecoats compositions in particular that enable the process to be run in a continuous wet-on-wet-on-wet fashion through a standard continuous automotive coatings line, while at the same time meeting current low overall solvent emission requirements, and a coated automotive substrate prepared according to the present process.

### BRIEF DESCRIPTION OF THE DRAWINGS

FIG. 1 is a general flow diagram of one embodiment of the tricoat application process according to the present invention.

FIG. 2 is a side elevational schematic diagram of the tricoat application process of FIG. 1.

FIG. 3 is a general flow diagram of a standard basecoat/clearcoat application process.

FIG. 4 is a general flow diagram of a prior art, basecoat/tinted clearcoat application process that requires double processing of a vehicle.

### DETAILED DESCRIPTION OF THE PREFERRED EMBODIMENTS

The present invention relates to the application of tricoat finishes on automotive substrates during their original manufacture. More particularly, it provides a process for coating the exterior of an automotive substrate such as an auto or truck body or parts thereof with a multi-layer tricoat coating, which eliminates the use of tinted clearcoats and their associated problems, while at the same time providing a finish that is of automotive quality and appearance that achieves high color saturation with excellent depth of color and desired glamour, without sacrificing durability and weatherability. The process of the present invention can be run in a batch or continuous process. Ideally, it is designed to be run in existing basecoat/clear coat painting facilities, such as continuous in-line or modular batch facilities, located at an automotive assembly plant without the need to reconfigure (e.g., spur) or slow down the line or extend the painting time.

By replacing the tinted clear coat with a regular untinted clear coat, durability issues are now avoided. Also, since the desired color enrichment is now obtained from an intermediate basecoat layer instead of a tinted clearcoat, there is no need for double processing of a vehicle and for an extra clearcoat paint circulation system. Instead, the existing basecoat paint circulation systems can be used which can accommodate multiple colors given that basecoats are more freely interchangeable.

The process of this invention is suitable for coating a variety of metallic and non-metallic substrates in a batch or continuous process. In a batch process, also referred to as a modular process, the substrate is stationary during each treatment step of the process, whereas in a continuous process the substrate is in continuous movement along the paint line in an assembly line fashion.

Useful substrates that can be coated according to the process of the present invention include a variety of metallic and non-metallic substrates such as plastic substrates, and combinations thereof. Useful metallic substrates include unprimed substrates or previously painted substrates, cold rolled steel, phosphatized steel, and steel coated with conventional primers by electrodeposition. Useful plastic materials include polyester reinforced fiberglass, reaction-injection molded urethanes, partially crystalline polyamides, and the like or mixtures thereof and their associated primers.

Preferably, the substrates that are coated according to the process of the present invention are used as components to fabricate automotive vehicles, including but not limited to automobiles, trucks, and tractors. The substrates can have any shape, but are usually in the form of automotive body components such as bodies, hoods, doors, fenders, bumpers and/or trim for automotive vehicles. The invention is most useful in the context of coating automotive bodies and components thereof traveling in continuous movement along an automotive assembly line.

Prior to treatment according to the process of this invention, the substrate may be previously primed or otherwise treated as conventional in the art. The three different coatings employed herein are then applied consecutively over the substrate in the manner described below.

The three different coating compositions that are used in the process of the present invention include: a first pigmented basecoat (groundcoat) which is formulated as either a solid color or as an effect color composition based on flake and/or other effect pigments; a second transparent or semi-transparent basecoat (midcoat) which is preferably free of flake or other effect pigments and is used to enrich the color shade of the first basecoat; and a regular untinted clearcoat as the topcoat. In order to meet the current standards of overall low solvent emissions, the first basecoat and the second basecoat are preferably, but not necessarily, formed from water borne compositions and the untinted clearcoat is formed from either a solvent borne, water borne or powder composition.

More specifically, the first basecoat (or groundcoat) composition employed in the present invention is a pigmented composition which may be formulated as a solid color (straight shade) or effect color coating of appropriate color, effect, and optional, but preferable hiding. Preferably, as indicated above, the first basecoat (effect or solid shade) used is a waterborne composition in order to meet the current low overall solvent emission requirements. “Effect” coatings, as are known in the art, generally contain one or more special effect flakes or other effect pigments and optionally other colored pigments or spheres which give the desired color, effect and optional, but preferable hiding. By the term “special effect flakes”, it is meant pigment flakes that have the ability to impart visible flop or two tone (e.g., metallic or pearlescent) effect to a coating film. The first basecoat composition employed could also be formulated as a solid color or straight shade coating of appropriate color and optional, but preferable hiding. “Straight shade” or “solid shade” coatings, as are known in the art, primarily contain colored pigments and exhibit no visible flop or two tone metallic effect.

The first basecoat (effect or solid shade) composition is also preferably formulated as a crosslinkable composition, which comprises mixtures of film-forming material or binder, volatile material, and pigment. Since the present invention is most useful in the context of waterborne basecoat compositions, the film forming binder preferably contains one or more water-compatible film forming materials such as an aqueous microgel, polyol polymer, or mixtures thereof, and a crosslinking agent such as an aminoplast resin.

Suitable microgels that can be used to form the basecoat composition include crosslinked polymer microparticle aqueous dispersions such as disclosed in Backhouse U.S. Pat. No. 4,403,003 issued Sep. 6, 1983 and Backhouse U.S. Pat. No. 4,539,363 issued Sep. 3, 1985, both hereby incorporated by reference. The microgel preferably contains appropriate functional groups, such as hydroxy groups, whereby they can become crosslinked, after application of the composition to the substrate by means of a crosslinking agent, e.g., the amino resin.

The aqueous polymer microgel suitable for use in this invention may be composed of various types of crosslinked polymers. Of particular interest for the purposes of this invention are crosslinked acrylic microgel particles. Preparation of such acrylic microgels may be carried out by methods which are well known and routinely practiced by those of ordinary skill in the art. Typically, the microgels are acrylic addition polymers mainly derived from one or more alkyl acrylates or methacrylates, optionally together with other ethylenically unsaturated copolymerizable monomers like styrene and vinyl esters. Suitable alkyl acrylates or methacrylates include, without limitation, alkyl acrylates and methacrylates each having 1-18 carbon atoms in the alkyl group. Since the polymer is required to be formed with internal crosslinking, there may be included in the monomers from which the polymer is derived a minor proportion of a monomer which is polyfunctional with respect to the polymerization reaction, such as ethylene glycol dimethacrylate, allyl methacrylate or divinylbenzene. Alternatively, there may be included in the monomers minor proportions of two other monomers carrying pairs of functional groups which can be caused to react with one another either during or after polymerization, such as epoxy and carboxyl (as for example, in glycidyl methacrylate and methacrylic acid), anhydride and hydroxyl, or isocyanate and hydroxyl. There also is preferably included in the monomers minor amounts of a hydroxy containing monomer for crosslinking purposes after application of the composition to the substrate from the following group: hydroxy alkyl acrylates or methacrylates, and any mixtures of other ethylenically unsaturated hydroxy monomers.

Acid functional monomers such as acrylic acid or methacrylic acid are also preferably included in the monomer mix to sterically stabilize the crosslinked microparticles in the aqueous dispersion medium by converting such groups to a suitable salt by reaction with a base, such as dimethylaminoethanol, dissolved in the aqueous medium. Alternatively, the required stability in the aqueous medium can be achieved by using an acrylate or methacrylate monomer containing basic groups, for example, dimethylaminoethyl methacrylate, which are neutralized with a suitable acid, such as lactic acid. Stability in the aqueous medium can also be achieved by use of surfactants or macromonomers which contain water soluble nonionic stabilizers such as materials which contain polyethylene glycol structures. By aqueous medium, it is meant either water alone or water admixed with a water-miscible organic co-solvent such as an alcohol. The crosslinked microgel particles so produced are provided in colloidal dimensions. The microgel particles that are particularly useful in this invention generally have a colloidal size from about 80 to 400 nanometers, in diameter, preferably from about 90 to 200 nanometers.

Suitable polyols useful for preparing the basecoat composition include water-compatible acrylic, polyester, polyester, polyurethane, polyether, or other polyol having a hydroxyl number of 50-200, as are conventional in the art. Suitable crosslinking materials include aminoplast resins soluble or partially in the aqueous medium of the composition, such as melamine-formaldehyde condensates and in particular alkylated melamine-formaldehyde condensates. Other contemplated crosslinking materials are alkylated urea formaldehyde condensates, benzoquanamine formaldehyde condensates and blocked polyisocyanates or compatible mixtures of any of the forgoing. Additional water-compatible film-forming and/or crosslinking polymers may be included in the basecoat employed in the present invention. Examples include water compatible acrylics, polyurethane, epoxies, or mixtures thereof. Alternatively or in addition to the film-forming polymers mentioned above, film-forming filler materials such as polyether glycols of low volatility, for e.g., low molecular polypropylene and/or polyethylene glycol, can be used to fill the voids formed by the microgel particles upon drying and improve the physical properties of the resulting film or finish. These oligomeric substances can be converted to high molecular weight polymer, after application of the basecoat composition, by linking them through their hydroxyl groups or other reactive groups to the aminoplast crosslinking resin.

One typically useful first basecoat, in addition to special effect pigments and flakes and/or other optional pigments, comprises by weight of binder solids, aqueous microgel for rheology control from about 20-80%, preferably 40-70%, such as but not limited to the crosslinked acrylic microparticle aqueous dispersions disclosed in aforementioned U.S. Pat. No. 4,403,003, water-soluble or partially water-soluble aminoplast resin, preferably a methylated melamine formaldehyde, from 10-40%, preferably 15-25%, water dispersible polyester polyol resin from about 0-40%, polyurethane polyol aqueous dispersion from 0-30%, preferably 5-15%, water-soluble polyether filler from 0-10%, water-soluble acid catalyst from about 0-2%, such as but not limited to a volatile amine blocked sulfonic acid catalyst, to promote melamine or other crosslinking reaction. The composition also includes 0.1-3%, preferably 0.3-1.0%, based on the weight of the total composition, sheet silicate particle, such as those disclosed in Berg et al. U.S. Pat. No. 5,198,490 issued Mar. 30, 1993, to help give the desired holdout or resistance to strike-in and intermixing.

The overall solids content of the first basecoat composition typically ranges from about 10 to 35% by weight (for e.g., a metallic or pearlcoat typically has 15-30% solids by weight, and a red solid color typically has 25-40% solids by weight).

A wide variety of pigments may be employed in the first basecoat to give the desired color and/or effect and optional hiding. The first basecoat generally contains one or more special effect flake and other effect pigments, and/or optionally one or more color pigments, depending on if it is formulated as an effect color or a solid shade.

Typical special effect flakes that can be used include metallic flakes such as aluminum flake, copper bronze flakes, pearlescent (e.g., mica) flakes, vacuum metalized flakes, glass flakes, and the like. Other effect pigments that can be used include holographic flakes, glass spheres, micro titanium dioxide pigments, Graphitan® pigments, and higher degree effect pigments including, for instance, Xirallic®, Colorstream®, Mearlite®BBT, Chromaflair®, Variochrome®, and Helicone® pigments, and the like. Typical colored pigments that can be used include metal oxides such as titanium dioxide, zinc oxide, iron oxides of various colors, carbon black, and a wide variety of organic colored pigments such as quinacridones, phthalocyanines, perylenes, azo pigments, indanthrone blues, carbazoles such as carbozole violet, isoindolinones, isoindolones, thioindigo reds, benzimidazolinones, , diketo-pyrrolo-pyrroles (DPP) and the like. When the coating contains metallic pigments such as aluminum flakes, agents which inhibit the reaction of the pigments with water may be added. Typical inhibitors are phosphated organic materials such as phosphoric acid and other materials as described in U.S. Pat. No. 4,675,358.

The specific pigment to binder ratio can vary widely so long as it provides the requisite color, effect and hiding at the desired film thickness and application solids. The pigments can be introduced into the basecoat by first forming a mill base or pigment dispersion with any of the aforementioned polymers used in the coating composition or with another compatible polymer or dispersant by conventional techniques, such as mixing/slurrying (i.e., for flakes), high speed mixing, media milling, sand grinding, ball milling, attritor grinding or two/three roll milling. The pigment dispersion is then blended with the other constituents used in the coating composition.

The second basecoat employed in this invention is formulated to be transparent or semi-transparent and is differently pigmented than the first basecoat composition. The second basecoat usually contains only colored and/or uncolored inorganic and/or organic pigments, preferably transparent By uncolored, it is meant pigments such as extender pigments that do not impart a color to the coating but provide a functional effect such as improved adhesion. Alternatively, special effect flakes or effect pigments can be included to impart the desired color and effect. Alternatively, it may contain no pigments whatsoever. This intermediate basecoat is used to enrich or enhance the color shade of the first basecoat, without the use of a tinted clearcoat and all its associated problems. Most preferably, the second basecoat is a pigmented composition and is in the same color area (e.g., red over red, blue over blue, yellow over yellow, etc.) as the first basecoat, in order to provide the desired enhanced color saturation and depth of color effect. Alternatively, the second basecoat may be formulated in different color area (e.g., red over silver, yellow over blue, etc.) for a different color effect.

The second basecoat is also preferably formulated as a waterborne formulation and any of the ingredients listed above for use in the first basecoat may be included in the second basecoat, usually except for the special effect flakes. One typically useful second, differently pigmented, transparent basecoat, in addition to optional colored pigments, comprises by weight of binder solids, aqueous microgel for rheology control from about 20-80%, preferably 50-70%, water-soluble or partially water-soluble aminoplast resin, preferably a methylated melamine formaldehyde, from about 10-40%, preferably 15-25%, water dispersible polyester polyol resin from about 0-40%, aqueous polyurethane polyol dispersion from about 0-30%, preferably 15-15%, water-soluble polyether filler from 0-10%, blocked acid catalyst from about 0-2%, such as but not limited to amine blocked sulfonic acid catalyst, to promote melamine or other crosslinking reaction. The composition also includes 0.1-3%, preferably 0.3-1.0%, based on the weight of the total composition, sheet silicate particle to help give the desired holdout or resistance to strike-in and intermixing.

The overall solids content of the second basecoat composition typically ranges from about 15 to 40% by weight (for e.g., a colored transparent basecoat typically has 20-30% solids by weight).

Both basecoat compositions employed in the present invention may also include other conventional formulation additives such as wetting aids, surfactants, defoamers, UV fortifiers, and rheology control agents, such as fumed silica, alkali swellable emulsions, associative thickeners, or water compatible cellulosics.

Both basecoat compositions employed in this invention also include volatile materials. For waterborne basecoats, which are preferred, the volatile materials generally include water alone or water in admixture with conventional water-miscible organic solvents and diluents, to disperse and/or dilute the above mentioned polymers and facilitate formulation and spray application. Typical water-miscible organic co-solvents and diluents include toluene, xylene, butyl acetate, acetone, methyl isobutyl ketone, methyl ethyl ketone, methanol, isopropanol, butanol, butoxyethanol, hexane, acetone, ethylene glycol, monoethyl ether, VM and P naptha, mineral spirits, heptane and other aliphatic, cycloaliphatic, aromatic hydrocarbons, esters, ethers and ketones and the like. However, in a typical basecoat for this invention, water is used as the major diluent. Amines such as alkanolamine can also be used as a diluent. For additional examples of the various constituents that may be selected for use in the waterborne basecoat compositions employed herein, reference can be made to any of the aforementioned U.S. Pat. Nos. 4,403,003, 4,539,363, and 5,198,490, all previously incorporated by reference herein.

The nature of the clearcoat composition employed in the process of the present invention is in no way critical. Preferably, an untinted transparent clearcoat is used. By untinted, it is meant that the clearcoat contains no pigments. Any of a wide variety of commercially available automotive clearcoats may be employed in the present invention, including standard solvent borne, waterborne or powdered clears. High solids solvent borne clear coats which have low VOC (volatile organic content) and meet current pollution regulations are generally preferred. Typically useful solventborne clearcoats include but are not limited to 2K (two component) systems of polyol polymers crosslinked with isocyanate and 1K systems of acrylic polyol crosslinked with melamine or 1K acrylosilane systems in combination with polyol and melamine. Epoxy acid clearcoat systems can also be used. Such finishes can provide automobiles and trucks with a mirror-like exterior finish having an attractive aesthetic appearance, including high gloss and DOI (distinctness of image). Suitable 1K solvent borne acrylosilane clearcoat systems that can be used in the process of the present invention are disclosed in U.S. Pat. No. 5,162,426, hereby incorporated by reference. Suitable 1K solvent borne acrylic/melamine clearcoat systems are disclosed in U.S. Pat. No. 4,591,533, hereby incorporated by reference.

According to the present invention, the three coating compositions described above can be applied by, but is not limited to, conventional techniques such as spraying, electrostatic spraying, high rotational electrostatic bells, and the like. The preferred techniques for applying all three coatings are air atomized spraying with or without electrostatic enhancement, and high speed rotational electrostatic bells, since these techniques are typically employed in a continuous paint application process.

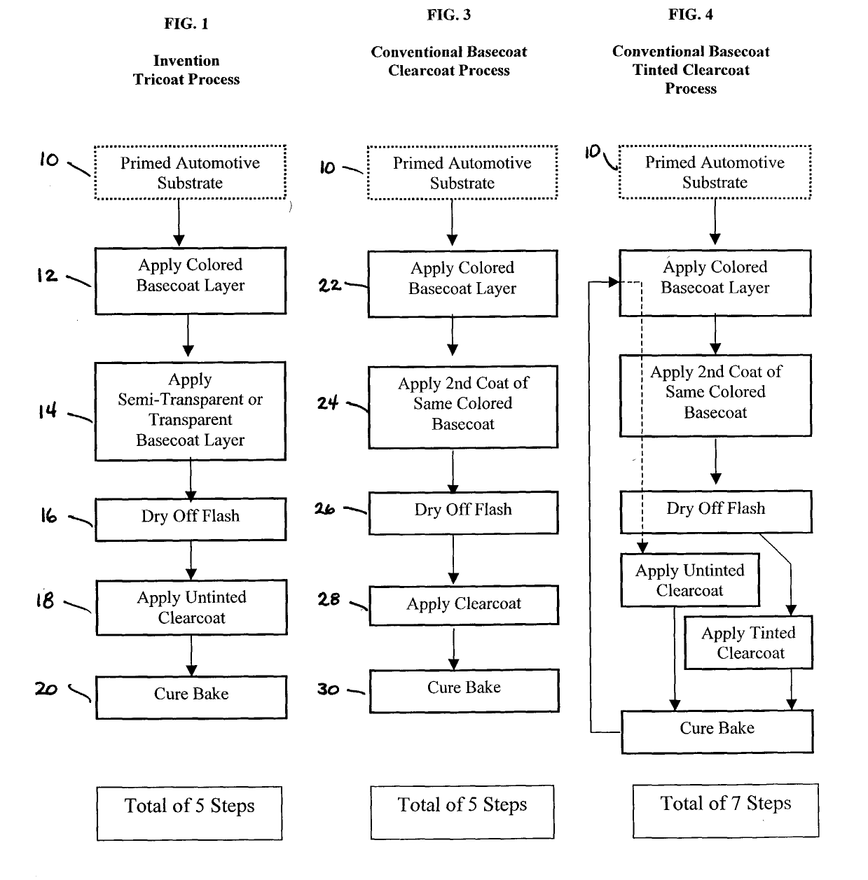

Referring now to the drawings, there is shown in FIG. 1 a flow diagram of a multi-stage tricoat process for coating a substrate according to the present invention.

The present invention will now be discussed generally in the context of coating an automotive substrate in continuous movement along a standard continuous automotive coatings line with waterborne basecoats and high solids solvent borne clearcoats. One skilled in the art would understand that the process of the present invention is also useful in other types of continuous or batch processes and with other types of basecoat and clearcoat systems.

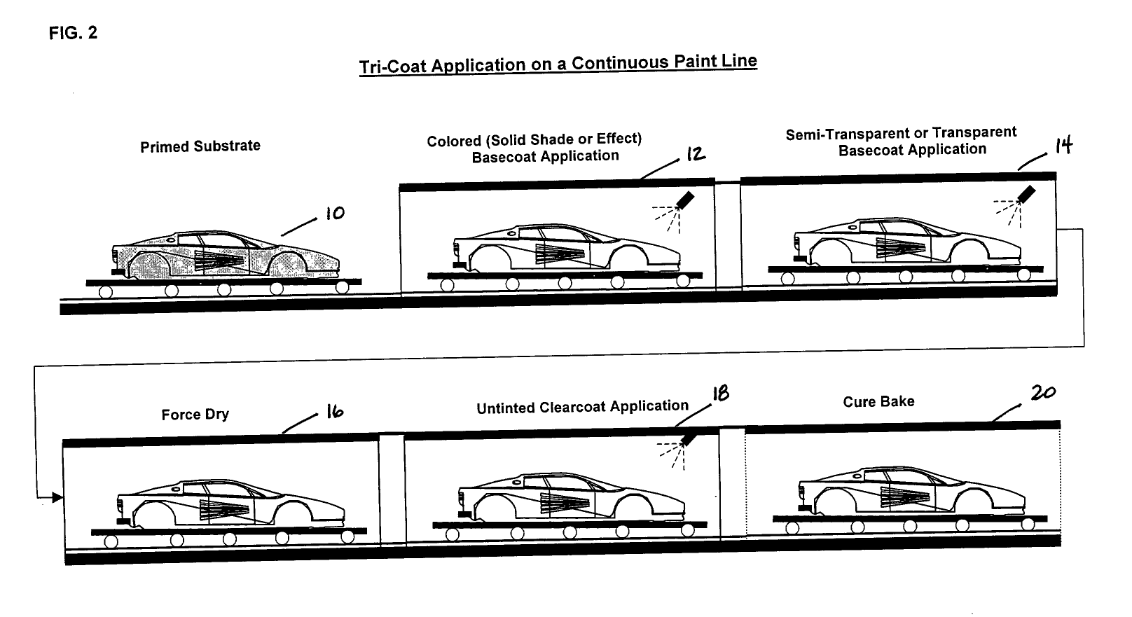

Prior to treatment according to the process of this invention, the automotive substrate 10 may be previously primed or otherwise treated as conventional in the art. In the first operational step 12 of the process as shown in FIG. 1, the first liquid waterborne basecoat or groundcoat composition is then applied to the surface of the primed automotive substrate (such as the automobile body shown in FIG. 2), preferably over an electrodeposited coating or primer surfacer. The first liquid basecoat can be applied to the surface of the substrate in this step by any suitable coating process well known to those skilled in the art, such as by any of the techniques described above. The method and apparatus for applying the liquid basecoat composition to the substrate is determined in part by the configuration and type of substrate material.

After application of the first basecoat (effect or solid shade) layer, the process of the present invention includes a second step 14 of directly applying the second liquid waterborne transparent basecoat composition (midcoat) over the first waterborne basecoat composition, as the vehicle travels along the assembly line, by means of a wet-on-wet application, i.e., the second basecoat is applied to the first basecoat without curing or completely drying the first basecoat. The second liquid basecoat can be applied in this step by any suitable coating process known to those skilled in the art, such as by any of the techniques described above. In the present process, the second basecoat is applied within about 30 seconds to 5 minutes of the first basecoat application, preferably within about 2-4 minutes of application, which is the typical dwell time in a conventional basecoat spray booth for basecoat/clearcoat systems.

Therefore, unlike conventional tricoat processes that involve the application of two different types of waterborne basecoats, an intermediate drying step or bake is not needed before applying a subsequent basecoat thereover. This allows the present process to be run in a single pass in existing basecoat/clearcoat painting facilities without the need to reconfigure (e.g., spur) or slow down the paint line or extend the painting time.

To demonstrate how the present invention can be run in existing basecoat/clearcoat vehicle paint lines, a traditional single pass basecoat/clearcoat continuous paint application process is shown in FIG. 3. In this process, an automobile steel panel or plastic substrate 10, which may be previously primed or otherwise treated as conventional in the art, is moved to a continuous in-line basecoat/clearcoat application area. A basecoat color is applied first to the surface of the substrate typically in two steps 22, 24 separated by 30-300 seconds between the first and second coats. Typical basecoats comprise a mixture of pigments, which may include special effect flake pigments, film-forming binder polymers and optionally crosslinking agents and others additives and solvents necessary for application. When the basecoats are waterbased systems, as is conventional in the art, it is also necessary to have a forced drying step 26 for removal of some of the water and any other organic liquid diluent contained therein before the clearcoat is applied in the next step 28. A clearcoat is then applied to the semi-dried pigmented basecoat. This is still commonly called a wet-on-wet process because the basecoat is not completely dried or cured before application of the clearcoat. The coated substrate is then baked in step 30 under standard conditions to simultaneously cure the basecoat and clearcoat composition on the surface and produce a finish of automotive quality and appearance.

In the present invention, in order to enable wet-on-wet application of the two different waterborne basecoat layers and thus single pass continuous processing of the tricoat finish of the present invention using existing basecoat/clearcoat continuous paint application lines, the first and second basecoats of the present invention must be formulated to have acceptable hold-out or resistance to strike-in and intermixing after about 30 seconds to 5 minutes at ambient conditions between coats, preferably after 1 to 4 minutes at ambient conditions. By controlling the rate at which the waterborne basecoats can achieve holdout, the present process can take advantage of the two existing basecoat stations found in existing continuous basecoat/clearcoat paint application lines (normally used to apply the same basecoat in two steps separated by 30-300 seconds) without the need to reconfigure the line. This in turn allows for wet-on-wet-on-wet processing of the entire tricoat finish in a single pass without the sacrificing of good control of the orientation of the flake or effect pigments and interfering with the special color effect (i.e., saturation, depth of color, brightness, flop) or color uniformity of the overall finish. Of course, if it is desired to reconfigure the line and extend the painting time, a drying zone as described below can be placed between the two basecoat application zones, although this would be undesirable for most automakers.

Furthermore, since the desired color enrichment and a tinted clearcoat style of color is now obtained from the second basecoat layer without the use a tinted clearcoat, there is no need to send the vehicle through the painting process a second time, as suggested in the conventional basecoat/tinted clearcoat application process which is shown in FIG. 4. Double processing of the vehicle and lost production can now be avoided.

After applying the second basecoat, the process of the present invention preferably includes a third step 16 of subjecting the combined basecoat layers to a drying step to volatilize at least a portion of the volatile materials from the liquid coating compositions and set the basecoats on the substrate. By set, it is meant that the basecoat is not disturbed or marred (waved or rippled) by air currents which may blow past the basecoated surface. The volatilization or evaporation of volatiles from the basecoat can be carried out in open air, but is preferably carried out in a forced drying chamber (“tunnel”) as shown in FIG. 2 in which heated air (40-100° C.) or dehydrated air is circulated at low velocity to minimize airborne particle contamination.

This step is commonly referred to as a flash drying step. The automobile body is positioned at the entrance to the drying chamber and slowly moved therethrough in assembly-line manner at a rate which permits the volatilization of the basecoat as discussed above. The rate at which the auto is moved through the drying chamber depends in part upon the length and configuration of the drying chamber. Overall, this intermediate drying step may last for 30 seconds to 10 minutes, although in normal assembly plants, this step should take from about 2-5 minutes.

The dried basecoat that is formed upon the surface of the automobile body is dried sufficiently to enable application of the clear topcoat such that the quality of the topcoat will not be affected adversely by further drying of the basecoat. Preferably, the dried basecoats, after application to the surface of the substrate, form a multilayer film which is substantially uncrosslinked, i.e., is not heated to a temperature sufficient to induce significant crosslinking and there is substantially no chemical reaction between the film-forming polymers and crosslinking material therein. If too much water is present, the topcoat can crack, bubble or pop during drying of the topcoat as water vapor form the basecoat attempts to pass through the topcoat.

Referring again to FIGS. 1 and 2, the process of the present invention comprises a next step 18 of applying a liquid or powder clear, untinted, transparent topcoat composition over the dried composite basecoat layers. The clearcoat can be applied by any of the methods described above. With liquid clearcoats, it has become customary, particularly in the auto industry, to apply the clear topcoat over a basecoat by means of a wet-on-wet application, i.e., the topcoat is applied to the basecoat without curing or completely drying the basecoat. As indicated above, the clearcoat is preferably applied over a basecoat which has been dried, preferably flash dried for a short period, before the clearcoat is applied. This is still commonly called a wet-on-wet process because the basecoat is not completely dried or cured. Although less preferred, the basecoat can be cured, if desired, before the liquid clear coat is applied.

Following the application of the clearcoat, the process of the present invention preferably comprises a curing step 20 in which the coated substrate is heated for a predetermined time period to allow simultaneous curing of the base and clear coats. The curing step can be carried out using hot air convection drying, infrared radiation, or a combination thereof. The three layer composite coating composition is preferably baked at 100-150° C. for about 15-30 minutes to form a cured tricoat finish on the substrate. As used herein, cured means that the crosslinkable components of the coatings are substantially crosslinked. By the term substantially crosslinked, it is meant that, although at least most curing has occurred, further curing may occur over time.

The process of the invention may also include a subsequent cooling step (not shown) to cool the tricoat finish to ambient temperatures before the vehicle is further worked on during its manufacture.

The thickness of the dried and cured composite tricoat finish is generally about 40-150 μm (1.5-6 mils) and preferably 60-100 μm (2.5-4 mils). The basecoats and clearcoat are preferably deposited to have thicknesses of about 3.0-40 μm (0.1-1.6 mils) and 25-75 μm (1.0-3.0 mils), respectively.

The following Examples illustrate the invention. All parts and percentages are on a weight basis unless otherwise indicated.

### EXAMPLE 1

### Basecoat Preparation

The following premixes were prepared:

A. Preparation of Iron Oxide Yellow Pigment Dispersion

The following pigment slurry was prepared, 38.0 g of de-ionized water, 1.0 g of acrylic microgel dispersion (as described in U.S. Pat. No. 4,403,003, Example 4), 30.5 g butoxyethanol, 7.5 g Cymel® 303 (alkylated melamine formaldehyde resin), 2.0 g of 10% dimethylethanol amine solution and 1.0 g Surfynol® 104 (surfactant). The above components were mixed together, 20.0 g of Bayferrox® 3910 (yellow iron oxide) was added and the resulting slurry was then pre-dispersed using a Cowles blade. The mixture was then ground in a horizontal beadmill until the desired particle size of less than 0.5 micron was achieved.

B. Preparation of Iron Oxide Red Pigment Dispersion

The following pigment slurry was prepared, 7.0 g of de-ionized water, 10.0 g of acrylic microgel dispersion (as described in U.S. Pat. No. 4,403,003, Example 4), 10.0 g butoxyethanol, 7.0 g Cymel® 303, 0.5 g of 10% dimethylethanol amine solution and 1.0 g Surfynol® 104. The above components were mixed together, 40.0 g of Bayferrox® 130M (red iron oxide) was added and the resulting slurry was then pre-dispersed using a Cowles blade. The mixture was then ground in a horizontal beadmill until the desired particle size of less than 0.5 micron was achieved before it was stabilized by adding a letdown solution containing 10.0 g of acrylic microgel dispersion (as described above) and 14.5 g of de-ionized water.

C. Preparation of Effect Pigment Concentrate (Xirallic®, Flake Pigment)

15.0 g of butoxyethanol was mixed with 10.0 g of de-ionized water and then 17.0 g of Xirallic® Radiant Red SW was added under stirring. This slurry was kept under agitation while 50.0 g of acrylic microgel dispersion (as described under A. above) was added. This mixture was stirred until a homogeneous, smooth slurry was produced, before the final addition of 0.3 g of a 10% dimethylethanol amine solution and 7.7 g of de-ionized water.

D. Preparation of Effect Pigment Concentrate (Iriodin®), Mica Flake)

15.0 g of butoxyethanol was mixed with 10.0 g of de-ionized water and then 17.0 g of Iriodin® 9524 SW was added under stirring. This slurry was kept under agitation while 50.0 g of acrylic microgel dispersion (as described under A. above) was added. This mixture was stirred until a homogeneous, smooth slurry was produced, before the final addition of 0.3 g of a 10% dimethylethanol amine solution and 7.7 g of de-ionized water.

E. Preparation of Irgazin® Red Pigment Dispersion

The following pigment slurry was prepared, 61.6 g of de-ionized water, 5.0 g of acrylic microgel dispersion (as described in U.S. Pat. No. 4,403,003, Example 4), 5.0 g butoxyethanol, 5.0 g Cymel® 303, 2.5 g Solsperse® 20000 (dispersant), 0.4 g of 10% dimethylethanol amine solution and 0.5 g Surfynol® 104. The above components were mixed together, 20.0 g of Irgazin® Red DPP BO was added and the resulting slurry was then pre-dispersed using a Cowles blade. The mixture was then ground in a horizontal beadmill until the desired particle size of less than 0.5 micron was achieved.

F. Preparation of Cinquasia® Magenta Pigment Dispersion

The following pigment slurry was prepared, 55.3 g of de-ionized water, 10.0 g of acrylic microgel dispersion (as described in U.S. Pat. No. 4,403,003, Example 4), 18.0 g butoxyethanol, 8.0 g Cymel® 303, 2.0 g Solsperse® 20000, 0.2 g of 10% dimethylethanol amine solution and 0.5 g Surfynol® 104. The above components were mixed together, 6.0 g of Cinquasia® Magenta RV 6843 was added and the resulting slurry was then pre-dispersed using a Cowles blade. The mixture was then ground in a horizontal beadmill until the desired particle size of less than 0.5 micron was achieved.

G. Preparation of Paliogen® Red Pigment Dispersion

The following pigment slurry was prepared, 46.3 g of de-ionized water, 15.0 g of acrylic microgel dispersion (as described in U.S. Pat. No. 4,403,003, Example 4), 20.0 g butoxyethanol, 8.0 g Cymel® 303, 2.0 g Solsperse® 20000), 0.2 g of 10% dimethylethanol amine solution and 0.5 g Surfynol® 104. The above components were mixed together, 8.0 g of Paliogen® Red L 3885 was added and the resulting slurry was then pre-dispersed using a Cowles blade. The mixture was then ground in a horizontal beadmill until the desired particle size of less than 0.5 micron was achieved.

H. Preparation of Irgacolor® Yellow Pigment Dispersion

The following pigment slurry was prepared, 50.5 g of de-ionized water, 5.0 g of acrylic microgel dispersion (as described in U.S. Pat. No. 4,403,003, Example 4), 5.0 g butoxyethanol, 5.0 g Cymel® 303, 2.5 g Solsperse® 20000, 1.0 g of 10% dimethylethanol amine solution and 1.0 g Surfynol® 104. The above components were mixed together, 30.0 g of Irgacolor® Yellow 3 GLM was added and the resulting slurry was then pre-dispersed using a Cowles blade. The mixture was then ground in a horizontal beadmill until the desired particle size of less than 0.5 micron was achieved.

I. Preparation of Carbon Black Pigment Dispersion

The following pigment slurry was prepared, 35.5 g of de-ionized water, 10.0 g of acrylic microgel dispersion (as described in U.S. Pat. No. 4,403,003, Example 4), 20.0 g butoxyethanol, 15.0 g Cymel® 303, 5.0 g Solsperse® 20000, 7.0 g of 10% dimethylethanol amine solution and 0.5 g Surfynol® 104. The above components were mixed together, 7.0 g of Carbon Black FW 200® was added and the resulting slurry was then pre-dispersed using a Cowles blade. The mixture was then ground in a horizontal beadmill until the desired particle size of less than 0.5 micron was achieved.

J. Preparation of Cromophtal® Red Pigment Dispersion

The following pigment slurry was prepared, 53.5 g of de-ionized water, 5.0 g of acrylic microgel dispersion (as described in U.S. Pat. No. 4,403,003, Example 4), 20.0 g butoxyethanol, 8.0 g Cymel® 303, 2.0 g Solsperse® 20000, 1.0 g of 10% dimethylethanol amine solution and 0.5 g Surfynol® 104. The above components were mixed together, 10.0 g of Cromophtal® Red A2B was added and the resulting slurry was then pre-dispersed using a Cowles blade. The mixture was then ground in a horizontal beadmill until the desired particle size of less than 0.5 micron was achieved.

K. Preparation of Rheology Base

A homogeneous blend of the following was prepared by mixing together and stirring: 47.5 g of acrylic microgel dispersion (as described under A. above), 2.0 g of buthoxyethanol and 0.5 g of Surfynol 104. 50.0 g of a 3% Laponite® RD (layered silicate) solution in de-ionized water was added under stirring and homogenized and dispersed using a horizontal beadmill.

### EXAMPLE 2

### Preparation of Waterborne Red Effect Color Basecoat (a “1^{st} Layer”) Composition

A waterborne red effect color basecoating composition was prepared by mixing together the following constituents under constant agitation in the order stated: Acrylic microgel dispersion as described in (1,A.), above—15.7 parts. Black pigment dispersion as described in (1,I.), above—1.6 parts. Magenta pigment dispersion as described in (1,F.), above—15.5 parts. Red pigment dispersion as described in (1,G.), above—30.2 parts. Cymel® 303—1.7 parts. Effect pigment concentrate “C” (Xirallic®) as described in (1,C.), above—15.3 parts. Effect pigment concentrate “D” (Iriodin®) as described in (1,D.), above—8.1 parts. Rheology base as described in (1,K.), above—9.0 parts. Surfynol® 104, 1.0 parts. The desired viscosity (2000-4000 mPas at shear rate D=1 sec⁻¹) and the desired pH (pH 8.2-8.8) are adjusted with an appropriate combination of de-ionized water, a 10% n.v. pre-neutralized solution of Acrysol® ASE 60 in de-ionized water and a 10% dimethylethanol amine solution in de-ionized water, in such a way that the amount of these products used totals approximately 1.9 parts.

### EXAMPLE 3

### Preparation of Waterborne Red Solid Color Basecoat (a “1^{st} Layer”) Composition

A waterborne red solid color basecoating composition was prepared by mixing together the following constituents under constant agitation in the order stated: Acrylic microgel dispersion as described in (1,A.), above—36.5 parts. Red pigment dispersion as described in (1,E.), above—22.8 parts. Red pigment dispersion as described in (1,J.), above—11.4 parts. Yellow pigment dispersion as described in (1,H.), above—5.3 parts. Red pigment dispersion as described in (1,B.), above—3.4 parts. Yellow pigment dispersion as described in (1,A.), above—2.3 parts. Cymel® 303—5.3 parts. Rheology base as described in (1,K.), above—9.2 parts. Surfynol® 104, 1.8 parts. The desired viscosity (2000-4000 mPas at shear rate D=1 sec⁻¹) and the desired pH (pH 8.2-8.8) are adjusted with an appropriate combination of de-ionized water, a 10% n.v. pre-neutralized solution of Acrysol® ASE 60 in de-ionized water and a 10% dimethylethanol amine solution in de-ionized water, in such a way that the amount of these products used totals approximately 2.0 parts.

### EXAMPLE 4

### Preparation of Waterborne Transparent Red Color Basecoat (a “2^{nd} Layer”) Composition

A waterborne transparent red color basecoating composition was prepared by mixing together the following constituents under constant agitation in the order stated: Acrylic microgel dispersion as described in (1,A.), above—38.9 parts. Red pigment dispersion as described in (1,G.), above—5.1 parts. Cymel® 303—5.8 parts. Rheology base as described in (1,K.), above—11.0 parts. Buthoxyethanol, 6.1 parts. Surfynol® 104, 1.0 parts. The desired viscosity (2000-4000 mPas at shear rate D=1 sec⁻¹) and the desired pH (pH 8.2-8.8) are adjusted with an appropriate combination of de-ionized water, a 10% n.v. pre-neutralized solution of Acrysol® ASE 60 in de-ionized water and a 10% dimethylethanol amine solution in de-ionized water, in such a way that the amount of these products used totals approximately 32.1 parts.

### EXAMPLE 5

### Solventborne Clearcoat

The clearcoat composition used for the examples was a collision baking clear, which is commercially available from Du Pont Performance Coatings (Standox), Christbusch 25, D-42285 Wuppertal/Germany, with following details: Standocryl 2K-HS Klarlack, 020-82497 (in the US, code number is Standox HS Clear 14580), to be activated at a ratio of 2:1 with Standox 2K Haerter HS 15-25, 020-82403.

### EXAMPLE 6

### Application of 2 Different Basecoats and Clearcoat (Wet-on-wet-on-wet)

Standard automotive metal car doors have been processed and prepared with standard automotive pre-treatment and coatings systems, up to the primer/surfacer layer. They were then processed through a standard continuous basecoat/clearcoat automotive type application line at a continuous line speed of approximately 4 m/min, whereby the 1^{st} layer coat (effect color or solid color respectively—as described in examples 2 and 3 above) was applied with an electrostatic bell at a flow rate of 120 cc/min. After 2 minutes under ambient conditions (i.e. 22° C., 60% r.h.), the 2^{nd} layer coat (as described in example 4 above) was applied on top of the respective 1^{st} layer coats, effect color or solid color, wet on wet, by pneumatic atomization with robots, at a flow rate of 520 cc/min. This was then followed by a standard force dry in a drying tunnel for approximately 5 minutes @ 60° C., after which, following the normal automotive line procedures, a commercial clearcoat (in this case, a 2K isocyanate solvent based clearcoat, Standox® HS Clear 14580, commercially available from DuPont Company) was applied electrostatically, and the entire system was stoved @ 10 minutes/120° C. Film builds were as follows:

1^{st} layer coats: 10-12 microns (effect and solid shade respectively)

2^{nd} layer coat: 7-10 microns

Clearcoat: 40-45 microns

The system exhibited very good hold out. Neither sagging, nor film cracking nor any other defects were observed. The appearance and general quality of the resulting finish was comparable to that of normal automotive colors run on automotive paint lines. Color effects were achieved with this approach, which simulated the appearance and saturation which to date have only been possible with tinted clearcoats. The appearance, and mechanical properties of the finished system are not affected by this approach. Also, subject to pigment selection, weathering durability (i.e. Florida or accelerated) is not detrimentally affected, unlike with tinted clearcoats.

Subsequent work under a variety of application conditions (1^{st} layer coat flowrate 70-160 cc/min; 2^{nd} layer coat flowrate 400-600 cc/min; flash off time 1-5 minutes; ambient conditions) confirmed above outcome and exhibited a wide application window for this system, and the coatings thus obtained had similar excellent characteristics as that described above.

What is claimed is:

1. A process for coating an automotive substrate with a tricoat finish to achieve a highly saturated color appearance, comprising:
(a) applying a first solid color or effect color basecoat composition to a surface of an automotive substrate;
(b) thereafter applying a second, different, transparent or semi-transparent basecoat composition;
(c) subjecting the combined basecoats to an intermediate drying step;
(d) applying over said basecoat layer, an untinted clear coat composition; and
(e) curing the tricoat finish together in a single bake.

2. The process of claim 1 wherein the second transparent or semi-transparent basecoat is free of flake pigments.

3. The process of claim 1 wherein said second transparent or semi-transparent basecoat is a different color from the first basecoat.

4. The process of claim 1 wherein said second transparent or semi-transparent basecoat is unpigmented.

5. The process of claim 1 wherein said second transparent or semi-transparent basecoat is in the same color area as the first basecoat.

6. The process of claim 1 wherein said second transparent or semi-transparent basecoat is in a different color area as the first basecoat.

7. The process of claim 1 wherein said first basecoat layer is with or without flake or other effect pigment(s).

8. The process of claim 1, wherein the paint application line is a modular or continuous in-line system.

9. The process of claim 1 wherein the first and second basecoats are waterborne basecoats.

10. The process of claim 1 wherein the first and second basecoats are solventborne basecoats.

11. The process of claim 1 wherein the clear coat comprises melamine and polyol system; a polyol and isocyanate system; a melamine, polyol, and silane system; or an epoxy acid system.

12. The process of claim 1 wherein the clearcoat is a solvent borne, waterborne or powder clearcoat.

13. The process of claim 1 wherein the first basecoat has hiding.

14. The process of claim 1 wherein the first and second basecoats are applied over each other without an intermediate drying step.

15. The process of claim 1 wherein the process is run in a single wet-on-wet-on-wet pass on a continuously moving in-line automotive coatings line.

16. A process for eliminating the use of tinted clearcoats by coating an automotive substrate with a tricoat finish to achieve highly saturated color appearance, comprising:
(a) applying a first waterborne basecoat composition to a surface of an automotive substrate;
(b) thereafter applying a second, different, transparent waterborne basecoat composition without flake pigments to replace a tinted clearcoat;
(c) subjecting the combined basecoats to an intermediate drying step;
(d) applying over said basecoat layer, an untinted clear coat composition; and
(e) curing the three coat finish together in a final bake.

17. An automotive substrate coated with a tricoat finish according to the process of claim 1 or claim 16.
